(19) United States
(12) Patent Application Publication
(10) Pub. No.: US 2011/0208629 A1
(43) Pub. Date: Aug. 25, 2011

(54) CUSTOMER ACCOUNT NOTIFICATION MESSAGES

(75) Inventors: Stefani R. Benefield, Pensacola, FL (US); Jean Marsicano, Charlotte, NC (US); Sophia Chong Tolsma, Boston, MA (US); Kenneth Scott Jackowitz, Charlotte, NC (US)

(73) Assignee: BANK OF AMERICA CORPORATION, Charlotte, NC (US)

(21) Appl. No.: 12/712,634

(22) Filed: Feb. 25, 2010

(51) Int. Cl. G06Q 40/00

(52) U.S. Cl. 705/35

(57) ABSTRACT

Embodiments of the invention relate to apparatuses, methods, and computer program products for providing notification messages relating to observations made about a customer's use of an account that is held by a bank. For example, one embodiment of the invention provides a bank computer system having a memory communicably coupled to a communication device and a processor. In one embodiment, the memory stores information about the customer's use of account services and features, including online banking. The processor is configured to monitor the information and make observations about the customer's use of the account services and features, and use the communication device to communicate a notification message containing information relating to how the customer could better utilize the account services and features.

### FIELD

In general, embodiments of the invention relate to methods, systems and computer program products for providing customers with account notification messages.

### BACKGROUND

Financial institutions are continuously seeking effective ways “to onboard” customers. As used herein, “to onboard” or “onboarding” refers to a financial institution building its relationship with a customer just after that customer signs up for, or otherwise consumes, a financial product or service offered by the financial institution. Through its onboarding efforts, the financial institution seeks to retain the customer and, in some cases, expand its relationship with the customer to include other products and services. For example, if the customer opened a checking account, the financial institution, through onboarding, may attempt to retain the customer as a checking customer and persuade the customer to, for example, sign up for a credit card and/or take out a home-equity line-of-credit (HELOC).

Currently, to onboard a new customer, a financial institution gives that customer written information about the new financial product or service at the point-of-sale, which is typically a branch location or a call center. For example, if a customer opens a checking account at one of the financial institution's branch locations, an employee of the financial institution gives the customer pamphlets and brochures that provide information about the checking account's features and how to utilize the checking account. For example, the pamphlets and brochures provide information related to minimum balances, overdraft fees, opportunities to earn interest on deposits, how to order checks, how to use ATMs, how to obtain customer service, etc. Then, several weeks after the pamphlets and brochures were given to the customer, an associate of the financial institution follows up with the customer by calling the customer to answer any questions the customer may have and by mailing additional brochures and pamphlets.

However, these known onboarding techniques are sometimes ineffective because many customers do not read the pamphlets and brochures and because the telephone calls have very low contact rates. Further, preparing and distributing the brochures and pamphlets and making telephone calls require employee time and institutional resources that could be better used for other tasks. Therefore, there remains a need for an improved system for onboarding customers.

### SUMMARY OF EMBODIMENTS OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to systems, methods, and computer program products for providing notification messages relating to observations made about a customer's use of an account that is held by a bank. For example, one embodiment of the invention provides a bank computer system having a memory communicably coupled to a communication device and a processor. In one embodiment, the memory stores information about the customer's use of account services and features, including online banking. The processor is configured to monitor the information and make observations about the customer's use of the account services and features, and use the communication device to communicate a notification message containing information relating to how the customer could better utilize the account services and features.

For example, embodiments of the present invention provide an apparatus that comprises: (1) a communication device; (2) a memory device comprising information about transactions that occur in an account that is associated with a customer; and (3) a processing device communicably coupled to the communication device and the memory device. The processing device is configured to: (1) access the memory device to monitor the information about transactions that occur in the account; (2) make an observation about the use of the account by the customer based on the information about transactions that occur in the account; and (3) use the communication device to communicate the observation in the form of a notification message to an application running on a computer system associated with the customer.

Embodiments of the present invention also provide a method that comprises the step of storing in a memory device information about transactions that occur in an account that is associated with a customer and using a processing device to: (1) access the memory device to monitor the information about transactions that occur in the account; (2) make an observation about the use of the account by the customer based on the information about transactions that occur in the account; and (3) instruct a communication device to communicate the observation in the form of a notification message to an application running on a computer system associated with the customer.

Embodiments of the present invention also provide a computer a computer program product for providing notification messages to a customer associated with an account, the computer program product comprising a non-transitory computer-readable medium having computer-readable program instructions stored therein. The computer-readable program instructions comprise: (1) first instructions configured for storing in a memory device information about transactions that occur in the account that is associated with the customer; (2) second instructions configured for accessing the memory device to monitor the information about transactions that occur in the account; (3) third instructions configured for making an observation about the use of the account by the customer based on the information about transactions that occur in the account; and (4) fourth instructions configured for instructing a communication device to communicate the observation in the form of a notification message to an application running on a computer system associated with the customer.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings:

FIG. 1 illustrates a customer-onboarding system and an environment in which the system exists and the methods described herein are implemented, in accordance with an embodiment of the invention;

FIG. 2 is a flow chart illustrating an exemplary method of onboarding customers, in accordance with an embodiment of the invention;

FIG. 3 is a flow chart illustrating an exemplary method of opening a new account, in accordance with an embodiment of the invention;

FIG. 4 provides an exemplary screen shot of an exemplary onboarding hub, in accordance with an embodiment of the invention;

FIG. 5 provides another exemplary screen shot of an exemplary onboarding hub, in accordance with an embodiment of the invention; and

FIG. 6 is a flow chart illustrating an exemplary method of operation of a notification widget to provide customers with updates regarding their financial account(s), in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of apparatuses, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

It should be understood that terms like “bank,” “financial institution,” and “institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, credit card companies, payment network companies (e.g., Visa®, MasterCard®, American Express®, etc.), and/or the like. Additionally, disclosed embodiments may suggest or illustrate the use of agencies or contractors external to the financial institution to perform some of the calculations, data delivery services, and/or authentication services described herein. Furthermore, the illustrations provided herein are examples only, and an institution or business may implement the entire invention on their own computer systems or even a single work station if appropriate databases are present and can be accessed.

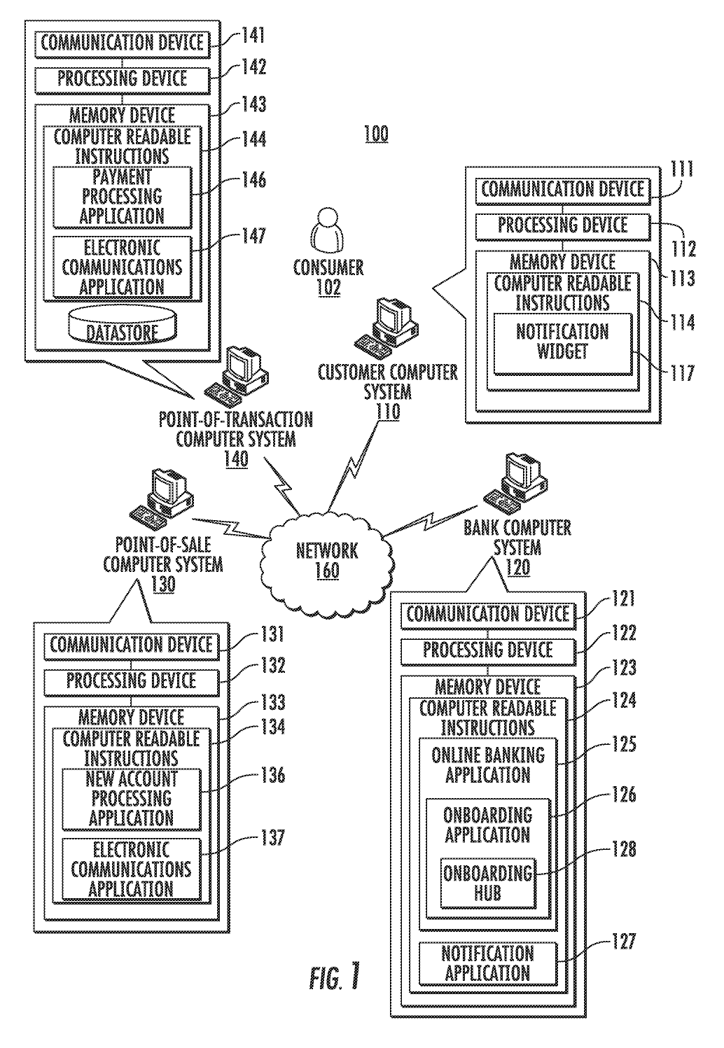

FIG. 1 illustrates an exemplary customer-onboarding system 100 environment in which an embodiment of the present invention exists. As shown in FIG. 1, in one embodiment, the customer-onboarding system 100 includes a customer computer system 110, a bank computer system 120, a point-of-sale (“POS”) computer system 130, and a point-of-transaction (“POT”) computer system 140. Although, for simplicity, FIG. 1 only illustrates one of each computer system, it will be appreciated that, in an embodiment of the invention, there will be many customer computer systems 110, many bank computer systems 120, many POS computer systems 130, and/or many POT computer systems 140. Also, although the POS computer system 130 and the bank computer system 120 are illustrated as separate systems, as described in more detail below, it should be appreciated that the POS computer system 130 and the bank computer system 120 can be combined into a single system.

Furthermore, although the term “bank” is used herein to describe an embodiment of the invention, other embodiments of the invention many involve other financial institutions in addition to or as an alternative to a bank. As used herein and in the claims, the term “financial institution” refers to an institution that provides financial products and services for purchase by customers. Customers can include, but are not limited to, individuals, non-business entities, and business entities, including small businesses. Financial institutions can include, but are not limited to, banks, building societies, credit unions, stock brokerages, asset management firms, savings and loans, money lending companies, insurance brokerages, insurance underwriters, dealers in securities, and similar businesses. As such, the bank computer system 120 of FIG. 1 could be the computer system of another financial institution involved in providing financial products and services for purchase by customers, but not traditionally thought of as a bank.

Referring again to the embodiment illustrated in FIG. 1, the customer computer system 110, the POS computer system 130, and the POT computer system 140 are operatively coupled, via a network 160, to the bank computer system 120. The network 160 may be a global area network (GAN), such as the Internet, a wide area network (WAN), a local area network (LAN), or any other type of network or combination of networks. The network 160 may provide for wireline, wireless, or a combination of wireline and wireless communication between devices in the network. It will be understood that when two components are described herein as communicating over a network, the components may be directly coupled to each other or indirectly coupled via one or more other components. Furthermore, although at least some of the systems described herein are described as having several unique components, these components need not be separate and distinct from one another, and two or more of such components may, in an embodiment, be combined into a single component that performs all of the functions of the multiple components so combined as described herein.

As illustrated in FIG. 1, the customer computer system 110 generally comprises a communication device 111, a processing device 112, and a memory device 113. The processing device 112 is operatively coupled to the communication device 111 and the memory device 113. The processing device 112 uses the communication device 111 to communicate with the bank computer system 120 over the network 160. The processing device 112 also uses the communication device 111 to communicate with the customer 102. As such, the communication device 111 generally comprises a modem, server, wireless card, radio, transceiver, and/or other device for communicating with other devices on the network 160, and a display, mouse, keyboard, microphone, touch pad, touch screen, speaker, and/or other device for communicating with the customer 102.

As used herein and in the claims, the term “processing device” generally refers to circuitry used for implementing communication and logic functions of the system in which it resides. A processing device may include, for example, a digital signal processor device, a microprocessor device, and various analog-to-digital converters, digital-to-analog converters, and other support circuits. Control and signal processing functions of a system are allocated between these processing devices according to their respective capabilities. The processing device may also include functionality to operate one or more computer applications based on computer-readable instructions (i.e., computer program code) thereof, which may be stored in a memory device in communication therewith. As used herein and in the claims, the term “memory device” generally refers to any device having computer-readable medium configured to store, for example, data and/or one or more computer applications.

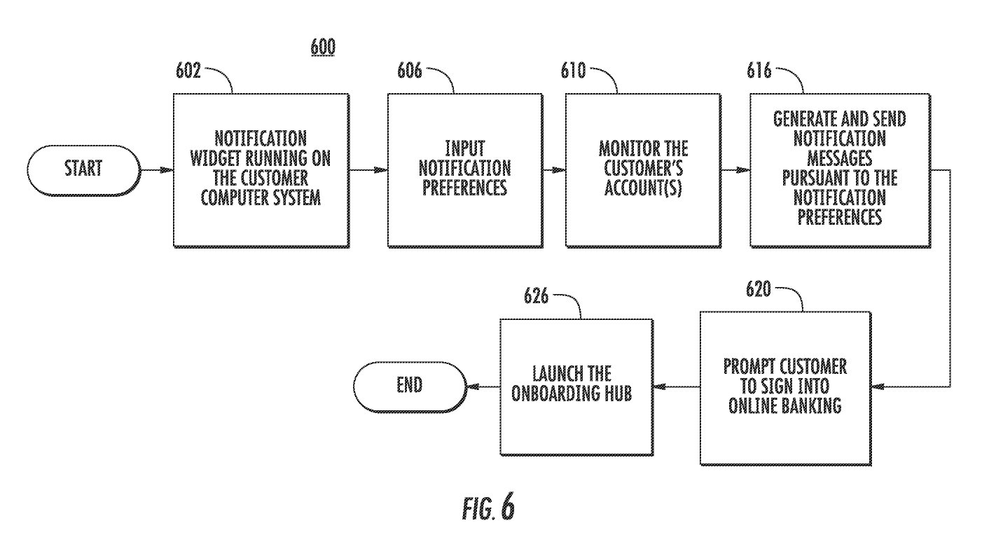

As further illustrated in FIG. 1, the customer computer system 110 includes computer-readable instructions 114 stored in the memory device 113, which include the computer-readable instructions 114 of a notification widget 117. The notification widget 117 includes one or more computer programs that, when executed by the processing device 112, allow the customer 102 to receive, store, and transmit electronic notification messages or access electronic notification messages via a website utilizing the communication device 111. In an embodiment, the notification widget 117 may also include an Internet browsing application or other application that allows the user to access an online banking platform operated by the bank computer system 120. The notification widget 117 is described in more detail below with reference to FIG. 6.

In one embodiment, the customer computer system 110 is a customer's desktop computer. In other embodiments, however, the customer computer system 110 is a customer's mobile computing device, which may include, for example, a mobile telephone, a personal digital assistant, a mobile picture taking device, a laptop computer, a mobile email device, a mobile texting device, a mobile music device, a wrist computer, and/or any other mobile terminal.

As illustrated in FIG. 1, the bank computer system 120 generally includes a communication device 121, a processing device 122, and a memory device 123. The processing device 122 is operatively coupled to the communication device 121 and the memory device 123. The processing device 122 uses the communication device 121 to communicate with the customer computer system 110, the POS computer system 130, and the POT computer system 140 over the network 160. As such, the communication device 121 generally comprises a modem, server, wireless card, radio or other device for communicating with other devices on the network 160. It should be understood that FIG. 1 illustrates only one embodiment of the customer onboarding system 100 of the present invention, and that, according to an embodiment, neither the POS computer system 130 nor the POT computer system 140 is required to implement the customer-onboarding methods and customer-notification methods of the present invention.

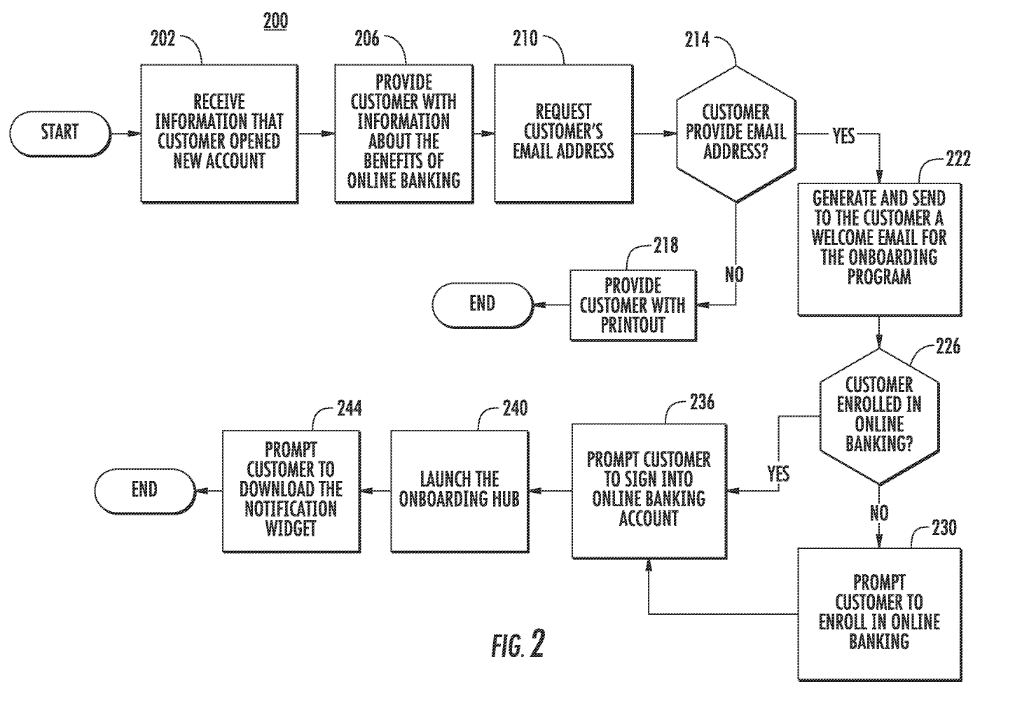

As further illustrated in FIG. 1, the bank computer system 120 includes computer-readable instructions 124 stored in the memory device 123. The computer-readable instructions 124 include an online-banking application 125 and a notification application 127. The online-banking application 125 provides an online-banking platform, which is an interactive web-based or mobile device solution that may be accessed by account holders to view their various account(s) and perform certain transactions, such as transaction inquiries, fund transfers, bill payments, etc. As illustrated in FIG. 1, the online banking application 125 includes an onboarding application 126. As described in more detail below with reference to FIG. 2, the onboarding application 126 includes an onboarding hub 128 that, when executed by the processing device 122, provides, for example: (1) online wizards that help the customer 102 set up his online account(s) and to utilize features of online banking; (2) a progress indicator that indicates the percentage that the customer 102 has set up his account(s)/online banking, e.g. 85% complete; (3) tutorials that instruct the customer 102 on how to use his account(s) and how to use online banking to manage his account(s); (4) auto-completed customer-referral forms and direct-deposit forms; and (5) a calculator that indicates the amount of money the customer 102 is saving by using the bank's products and services.

As described in more detail below with reference to FIG. 6, the notification application 127 includes one or more computer programs that utilize the communication device 121 to transmit electronic account notifications to the notification widget 117, which operates on the customer computer system 110 to provide account holders with account updates and notifications. Although FIG. 1 illustrates the bank computer system 120 as one system, it is important to note that there can be one or multiple systems, each with similar components that handle the various functions of the bank computer system 120. Further, although FIG. 1 illustrates the online banking application 125, the onboarding application 126, the onboarding hub 128, and the notification application 127 as four separate applications, it should be noted that the four applications can be combined or further divided into any number of applications, including a single application.

The POS computer system 130 generally includes a communication device 131, a processing device 132, and a memory device 133. The processing device 132 is operatively coupled to the communication device 131 and the memory device 133. The processing device 132 uses the communication device 131 to communicate with the bank computer system 120 and/or the customer computer system 110 over the network 160. As such, the communication device 131 generally comprises a modem, server, or other device(s) for communicating with other devices on the network 160. As further illustrated in FIG. 1, the POS computer system 130 contains computer-readable instructions 134 stored in the memory device 133, including computer-readable instructions 134 of the new-account-processing application 136. The new-account-processing application 136 generally includes one or more computer programs that, when executed by the processing device 132, perform account processing functions for, among other things, opening new account(s). For example, in the case of opening a new checking account, the new-account-processing application 136 receives the customer's personal information (e.g., name, address, telephone number, social-security number, etc), receives details about the account type (e.g., business or personal checking, minimum balance, etc.), receives an initial deposit, and sends the bank computer system 120 notification of the new account. Although FIG. 1 illustrates the POS computer system 130 as one system, it is important to note that there can be one or multiple systems, each with similar components that handle functions herein attributed to the POS computer system 130.

The POT computer system 140 generally includes a communication device 141, a processing device 142, and a memory device 143. The processing device 142 is operatively coupled to the communication device 141 and the memory device 143. The processing device 142 uses the communication device 141 to communicate with the bank computer system 120 and/or the customer computer system 110 over the network 160. As such, the communication device 141 generally comprises a modem, server, or other device(s) for communicating with other devices on the network 160. As further illustrated in FIG. 1, the POT computer system 140 contains computer-readable program instructions 144 stored in the memory device 143, including computer-readable instructions 144 of a payment processing application 146, and an electronic communications application 147. The payment processing application 146 generally includes one or more computer programs that, when executed by the processing device 142, perform payment processing functions, for example, in the case of a debit card payment, reading the debit card, contacting the issuing entity, requesting authorization from the issuing entity, receiving authorization from the issuing entity, and receiving the payment. The electronic communications application 147 includes one or more computer programs for receiving, storing, and transmitting electronic messages utilizing the communication device 141. Although FIG. 1 illustrates the POT computer system 140 as one system, it is important to note that there can be one or multiple systems, each with similar components that handle functions herein attributed to the POT computer system 140.

With reference now to FIG. 2, embodiments of the present invention are illustrated. In this regard, FIG. 2 is a flowchart illustrating an exemplary method 200 of onboarding customers, in accordance with an embodiment of the invention. According to an embodiment, the method 200 generally begins just after a customer 102 opens a new account with the bank and is designed to build the bank's relationship with the customer 102 so as to increase the likelihood that customer 102 will continue his relationship with the bank. For example, if the customer 102 just opened a checking account, the bank, through the method 200, attempts to, for example, introduce the customer 102 to the benefits of using online banking to manage the checking account and thereby retain the customer 102 as a checking customer. As used herein, the term “account” refers to a debit account, credit account, demand-deposit account, money-market account, brokerage account, savings account, or any other type of account that may held by at a bank. It should be appreciated that the customer 102 could be a new customer (i.e., a customer that has no open account(s) at the bank) or an existing customer (i.e., a customer that already has at least one open account at the bank).

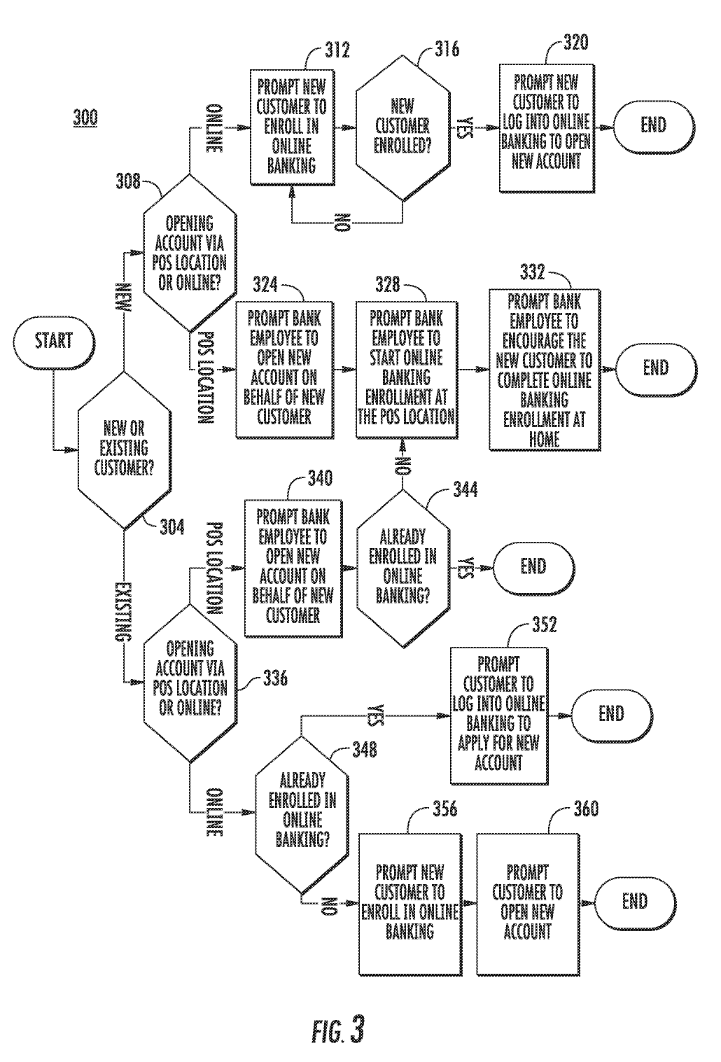

FIG. 3 provides a schematic flow diagram 300 that illustrates the process of opening a new account, in accordance with an embodiment of the invention. As indicated at block 304, the initial consideration is whether the customer is a new or existing customer. In the case of a new customer, the next consideration, as indicated at block 308, is whether the customer 102 is opening the account online or at a point-of-sale (“POS”) location, such as branch location or call center of the bank. As indicated at block 312, if the customer 102 is opening the new account online, then the customer 102 is prompted to enroll in online banking. As indicated at block 316, if the customer properly enrolls, then the customer 102 is prompted to log into online banking to open the new account, as indicated at block 320. Referring again to block 308, if the customer 102 is opening the new account at a POS location, then, as indicated at block 324, the bank employee is prompted to open the new account on behalf of the customer 102. Then, as indicated at block 328, the bank employee is prompted to encourage the new customer 102 to sign up for online banking by starting the enrollment process for the customer. After the bank employee has started the enrollment process, the bank employee is prompted to encourage the new customer 102 to complete the enrollment process at home, as indicated at block 332.

Referring again to block 304 of FIG. 3, if the customer 102 is an existing customer, then, as represented by block 336, the next consideration is whether the customer 102 is applying for the new account via online banking or at a POS location. In the case of an existing customer, like that of a new customer, opening the account may be accomplished by the customer 102 going to or calling a POS location, such as branch location or call center of the bank, and requesting that an employee or agent or associate of the bank open a new account on behalf of the customer 102. For example, upon receipt of the customer's request, the bank employee accesses the POS computer system 130 to process and open the new account for the customer 102, as indicated at block 340. The POS computer system 130 may be any type of computer system used for inputting, processing, and forwarding customer information and may be operated by or on behalf of any entity or multiple entities, including the bank. In this regard, the POS computer system 130 may be located at the POS location, or may be in a remote location. According to an embodiment, the POS computer system 130 would generally include the computer systems employed to collect, process, and forward the customer's information to the bank computer system 120, which is operated by or on behalf of the bank and is used to, among other things, maintain and administer the account(s) of the customer 102. In such a scenario, the POS computer system 130 may be owned and operated by the bank and may even be integrated with the bank computer system 120.

If the existing customer 102 is opening the new account via a POS location, the next consideration, as indicated at block 344, is whether the customer 102 is already enrolled in online banking. If the customer 102 is not already enrolled in online banking then, as indicated at block 328, the bank employee is prompted to encourage the new customer 102 to sign up for online banking by starting the enrollment process for the customer. After the bank employee has started the enrollment process, the bank employee is prompted to encourage the new customer 102 to complete the enrollment process at home, as indicated at block 328. According to some embodiments, the POS computer system 130 prompts the bank employee to start the enrollment process and encourage the customer 102 to complete the enrollment process at home.

Referring again to block 336, if the existing customer 102 is opening the new account online, then—as is also the case with a new customer—the existing customer 102 can open the new account using the customer computer system 110 to access online banking, which is provided by the online banking application 125 of bank computer system 120. Next, as indicated at block 348, if the customer 102 is already enrolled in online banking, then, as indicated at block 352, the customer 102 is prompted to log into online banking and open the new account. However, in the case of an existing customer that is not yet enrolled in online banking, opening the account, as indicated at block 356, may be accomplished by the customer 102 accessing the online banking website and enrolling in online banking. Then, as indicated at block 360, the customer 102 is prompted to open the new account.

According to some embodiments, the customer 102 may access online banking through the customer computer system 110. For example, the customer 102 may access online banking using the customer's mobile phone or other personal computing device. In such an embodiment, the mobile phone or other personal computing device may perform the functions of the customer computer system 110. It should also be appreciated that the customer's mobile phone or other personal computing device may perform the functions of the POS computer system 130. In other words, the customer's 102 mobile phone or other personal computing device may serve as both the customer computer system 110 and a portion of the POS computer system 130. Therefore, it will be understood that, while the POS computer system 130 is illustrated in FIG. 1 as separate from the customer computer system 110 and the bank computer system 120, it is possible that the customer computer system 110 or the bank computer system 120 could be combined with the POS computer system 130 and/or perform all of the functions attributed to the POS computer system 130. In other words, in an embodiment, the separations between the computer systems illustrated in FIG. 1 may be conceptual and one or more of the computer systems or portions thereof may be combined with one or more other computer systems or portions thereof.

With reference to FIG. 2 to, as represented by block 202, after the customer 102 opens a new account, the bank receives an indication that the customer 102 opened the new account. According to an embodiment, the bank receives, via the bank computer system 120, identifying information about the customer 102 and specific information about the new account. In this regard, according to an embodiment, the bank receives specific financial information about the customer 102, such as information the customer 102 provided when applying for the new account and/or information the customer 102 provided when becoming a customer of the bank, and specific information about the new account, such as account-type information that indicates the type, e.g., checking or credit, of the account. For example, if the new account is a credit account, the bank receives specific information about the customer's creditworthiness, banking preferences, and demographics as well as specific information about the credit account, such as interest rate and credit limit.

After receiving notice of the new account, the bank provides the customer 102 with information about the benefits of using online banking, as indicated by block 206. According to an embodiment, in addition to providing information about the benefits of using online banking, the bank provides the customer 102 with information about the onboarding hub 128, which is provided by the onboarding application 126 and which helps customers set up and use their account(s) and/or online banking. For example, the onboarding application 126 instructs the processing device 122 of the bank computer system 120 to instruct the POS computer system 130 to provide or prompt a bank employee to provide the customer 102 with information about the benefits of online banking and that the onboarding hub 128 is available to help them set up and use their account(s) and/or online banking. According to other embodiments, instead of the onboarding application 126, the new-account-processing application 136 instructs the processing device 132 of the POS computer system 130 to provide or prompt the bank employee to provide the customer 102 with information about the benefits of online banking and that the onboarding hub 128 is available to help them set up and use their account(s) and/or online banking.

For example, if the customer 102 just opened or is in the process of opening the account via a branch location or call center, the onboarding application 126 instructs the processing device 122 of the bank computer system 120 to instruct the POS computer system 130 to prompt the bank employee to explain the benefits of the onboarding hub 128. Also for example, if the customer 102 just opened or is in the process of opening the account via online banking, the onboarding application 126 instructs the online banking application 125 of the bank computer system 120 to display a webpage that explains benefits of the onboarding hub 128. Further, for example, a bank employee may be prompted to explain or the online banking website may from time to time present an existing customer 102 with the webpage that explains the benefits of the onboarding hub 128 and that by using the onboarding hub 128 the existing customer 102 may learn things about his account(s) and/or online banking that he may not have been otherwise known, even though the customer 102 already has account(s) and/or uses online banking. For example, the webpage may explain that the onboarding hub 128 is available at anytime to help the customer 102 better utilize features of online banking and/or his account(s). For example, the onboarding hub 128 provides online wizards that help the customer 102 set up his online account(s) and to utilize features of online banking, a progress indicator that indicates the percentage that the customer 102 has set up his account, tutorials that instruct the customer 102 on how to use his account(s) and how to use online banking to manage his account(s), auto-completed customer-referral forms and direct-deposit forms, and a calculator that indicates the amount of money the customer 102 is saving by using the bank's products and services.

As indicated by block 210 in FIG. 2, after providing benefit information about online banking and the onboarding hub 128, the bank requests the customer's email address. According to an embodiment, the onboarding application 126 instructs the processing device 122 of the bank computer system 120 to instruct the POS computer system 130 to prompt the bank employee to request the customer's email address. According to other embodiments, instead of the onboarding application 126, the new-account-processing application 136 instructs the processing device 132 of the POS computer system 130 to prompt the bank employee to request for the customer's 102 email address.

For example, in the event the customer 102 is opening the new account by visiting a branch location of the bank or by calling a call center of the bank, the request to collect the customer's email address, which is sent to the bank employee via the POS computer system 130, requests the bank employee operating the POS computer system 130 to ask the customer 102 for his/her email address and then input the customer's email address into the POS computer system 130, which then sends the customer's email address to the bank computer system 120. Also for example, instead of visiting a branch location or calling a call center to open a new account, in the event the customer 102 uses the customer computer system 110 to access online banking and set up a new account, the onboarding application 126 instructs the processing device 122 to send a request for the customer's email address to the customer computer system 110 via online banking. Then, using the customer computer system 110, the customer 102 can input his/her email address into online banking.

Then, as indicated by decision block 214, if the customer 102 is opening the account via a POS location, such as a bank branch or call center, and does not have or does not provide an email address, then an employee of the bank accesses the POS computer system 130 and inputs an indication that the customer 102 does not have or did not provide an email address. According to an embodiment, the POS computer system 130 communicates the no-email indication to the onboarding application 126. In this case, upon receipt of the no-email indication, the onboarding application 126 instructs the processing device 122 of the bank computer system 120 to instruct the POS computer system 130 to prompt the bank employee to provide the customer 102 with a printout of information about the benefits of online banking and that online banking includes the onboarding hub 128 that will help the customer 102 set up and use his account(s) and online banking, as represented by block 218.

According to other embodiments, the new-account-processing application 136 of the POS computer system 130 instructs the processing device 132 of the POS computer system 130 to prompt the bank employee to provide the customer 102 with a printout of information about the benefits of online banking and that the onboarding hub 128 is available to help the customer set up and use his account(s) and online banking. After the bank employee provides the customer 102 with a printout of the benefits of online banking and the onboarding hub 128, the exemplary method 200 may end. According to an embodiment, the printout includes the URL of an onboarding landing page, which is a webpage that further describes the benefits of online banking. The landing page instructs those customers who are already enrolled in online banking to log into online banking, and the landing page instructs those customers who are not yet enrolled in online banking to enroll and then log into online banking. According to some embodiments, the landing page provides a link that launches the online banking website where enrolled customers can log into online banking and where non-enrolled customers can enroll and then sign into online banking. After the customer 102 enrolls in and/or logs into online banking, the onboarding application 126 automatically launches the onboarding hub 128. For example, if the customer 102 is opening the account at a branch location, then an employee of the bank hands the printout to the customer 102. Also for example, if the customer 102 is opening the account via a call center, then an employee of the bank mails the printout to the customer 102.

On the other hand, also as indicated by decision block 214, if the customer 102 is opening the account via a POS location, such as a bank branch or call center, and does provide an email address, then an employee of the bank inputs the email address into POS computer system 130. According to an embodiment, the new-account processing application 136 of the POS computer system 130 communicates the email address to the bank computer system 120, and, after receipt of the email address, the onboarding application 126 instructs the processing device 122 of the bank computer system 120 to generate and send an email to the customer's email address, as represented by block 222. According to an embodiment, the email describes the benefits of online banking and the onboarding hub 128, and provides a link to the onboarding landing page. It should be appreciated that, instead of a link to the onboarding landing page, the link provided in the email could be a link that launches the online banking website. According to other embodiments, the new-account-processing application 136 of the POS computer system 130, instead of the onboarding application 126 of the bank computer system 120, generates and sends the email, which describes the benefits of online banking and the onboarding hub 128 and provides a link to the onboarding landing page.

If the customer 102 provided an email address when opening the new account via a POS location, such as a bank branch or call center, and if the bank computer system 120 or the POS computer system 130 sent the email describing the benefits of online banking to the customer's email account, then, the customer 102, upon clicking on the link embedded in the email, is directed to the onboarding landing page. As indicated at decision block 226, if the customer 102 is not already enrolled in online banking, then the onboarding landing page prompts the customer 102 to enroll in online banking, as indicated by block 230. According to an embodiment, the onboarding landing page includes a link that the customer 102 can click on to access online banking, which is hosted by the online banking application 125 of the bank computer system 120. More specifically, according to an embodiment, the link routes the customer 102 to an online-banking enrollment page, where the customer 102, using the customer computer system 110, inputs information necessary to enroll in online banking.

Also, as indicated at decision block 226, if the customer 102 is already enrolled in online banking, then the onboarding landing page prompts the customer 102 to log into online banking, as represented by block 236. After the customer 102 logs into online banking or after the customer enrolls and then logs into online banking, the onboarding application 126 launches the onboarding hub 128, as represented by block 240. The onboarding hub 128, because it is supported by the bank computer system 120, has access to customer information and is thereby able to determine which account(s) the customer 102 opened and to give the customer 102 specific and personalized information about the account(s) and how to use online banking to manage the account(s). Further, the onboarding hub 128 provides the customer 102 information that is tailored to suit the customer's demographics and previous banking patterns.

According to an embodiment, when the customer 102 clicks on the link provided in the email, which is generated and sent to the customer 102 according to the description above with reference to block 222, instead of the online banking application 125 launching the onboarding landing page or the online banking website, the onboarding application 126 instructs the processing device 122 of the bank computer system 120 to launch the onboarding hub 128.

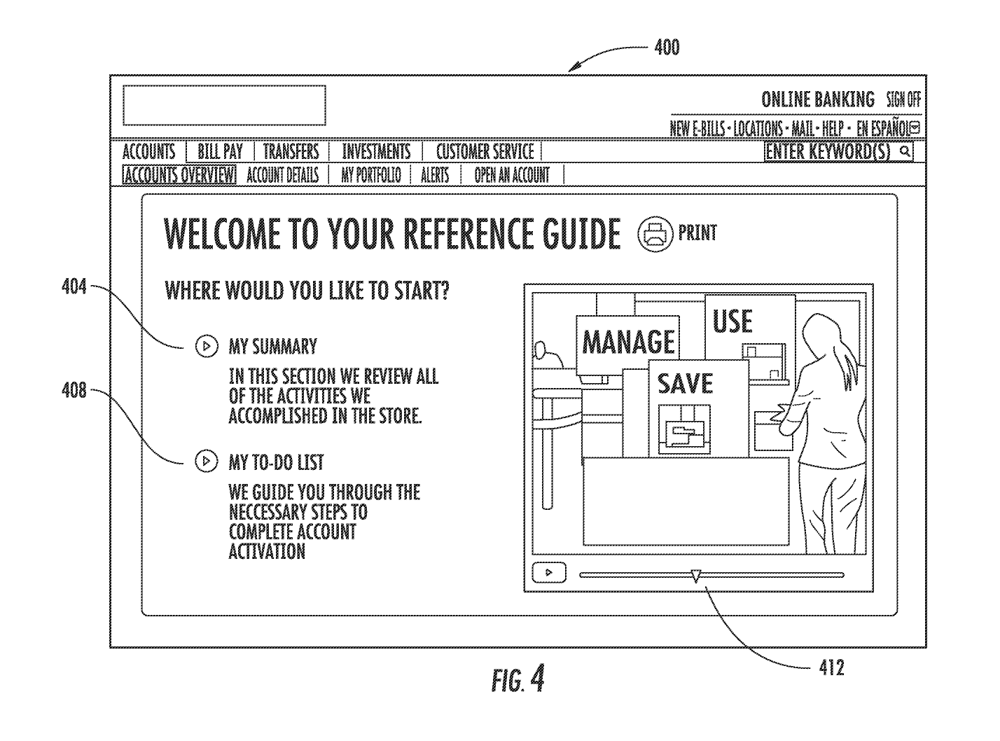

With reference to FIG. 4, an exemplary screen shot 400 of an aspect of the onboarding hub 128 is provided. If, for example, the customer 102 begins enrollment in online banking at a POS location, e.g., a bank employee begins the enrollment process for the customer, then the onboarding hub 128, upon the customer logging into online banking to complete enrollment, presents a screen similar to that of screen shot 400, which is designed to onboard the customer 102. In the illustrated embodiment, the customer 102 has the option of clicking on the “My Summary” link 404, which directs the customer 102 to a webpage that presents information that provides the customer 102 with a review of what the customer 102 accomplished when opening the account at the POS location. For example, the webpage may provide the customer 102 with an overview of the account features. Also, according to the illustrated embodiment, the customer 102 may click on the “My To-Do List” link 408, which directs the customer 102 to a webpage that provides a list of tasks necessary to complete activation of the new account. In some embodiments, webpage provides links that direct the customer to an online wizard that guides the customer 102 through the activation process. Further, as indicated at 412, according to this embodiment, the onboarding hub 128 provides a tutorial video that summarizes what was accomplished in the POS location, the account features, and/or the steps required to complete activation of the new account.

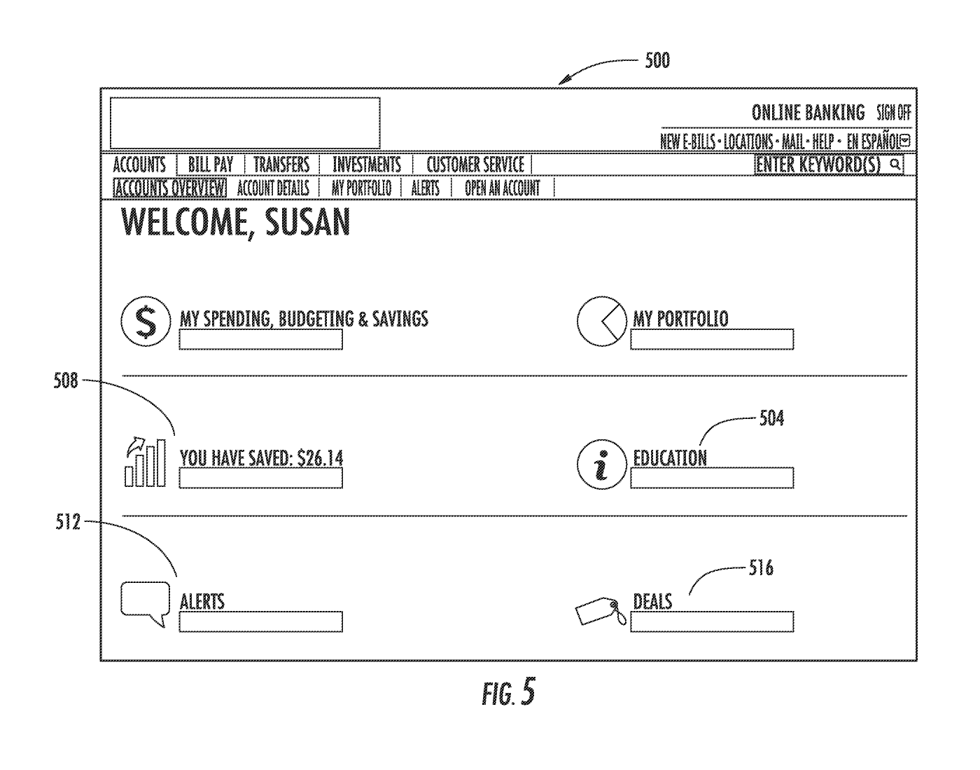

Referring now to FIG. 5, another exemplary screen shot 500 of an aspect of the onboarding hub 128 is provided. In this embodiment, the onboarding hub 128 launches each time the customer logs into online banking. As indicated by the screen shot 500, the onboarding hub 128 provides the customer with, for example, a link 504 to an educational page, where the customer can, among other things, view tutorials and launch wizards. Also, for example, the onboarding hub 128, according to the illustrated screen shot 500, provides a link 508 to a webpage that details how much money the customer 102 has saved by having an account with the bank. Exemplary link 512 directs the customer 102 to a webpage that lists account alerts that are relevant to the customer account(s). According to some embodiments, the icon associated with the link 512 may change to an unread-alert icon that indicates to the customer 102 that new alerts are available. Exemplary link 516 directs the customer 102 to a webpage that lists deals that the bank is currently promoting. This enables the bank to expand its relationship with the customer 102 into other products and services. It should be appreciated that screen shot 500 is an illustrative example of the onboarding hub 128. In other embodiments, onboarding hub 128 may, for example, provide links that direct the customer 102 to webpages where the customer 102 can view a progress indicator that indicates the percentage that the customer 102 has set up his account(s)/online banking, e.g. 85% complete and obtain auto-completed customer-referral forms and direct-deposit forms.

Referring again to FIG. 2, according to an embodiment, as indication at block 244, after the customer 102 has used the onboarding hub 128 to set up and use online banking, the onboarding hub 128 prompts the customer 102 to download the notification widget 117. If the customer 102 elects to download the notification widget 117, then the onboarding hub 128 facilitates downloading a copy of the notification widget 117 from the bank computer system 120 to the customer computer system 110. Once installed on the customer computer system 110, the notification widget 117 resides on the desktop of the customer computer system 110, communicates with the notification application 127 of the bank computer system 120, and provides the customer 102 with occasional updates about the customer's account(s). For example, the notification widget 117 provides notifications when e-statements are available, when certain transactions are complete, when an account balance drops below a threshold amount, etc. Also, for example, the notification widget 117 monitors the customer's 102 banking activity and provides the customer with customized advice on how to better utilize the products and services offered by the bank. For example, if the notification widget 117 observes that the customer 102 only makes teller deposits, then the notification widget 117 provides the customer 102 with a tutorial on how to save time by making ATM deposits.

Referring now to FIG. 6, the notification widget 117 will be described in more detail. FIG. 6 is a flow chart illustrating an exemplary method of operation for the notification widget 117, in accordance with an embodiment of the invention. As represented by block 602, the exemplary operation of the notification widget 117 generally begins with the notification widget 117 running on the customer's 102 customer computer system 110. For example, according to an embodiment, when the notification widget 117 is running, an icon that represents the notification widget 117 appears on the desktop of the customer computer system 110. For example, the icon for the notification widget 117 appears in a taskbar or a dock of the customer computer system 110 and alerts the customer 102 when a new notification has arrived.

As represented by block 606, the method 600 further involves the customer 102 inputting preferences for the notification widget 117. For example, according to an embodiment, the customer 102 accesses the notification widget 117 via the customer computer system 110 and inputs preferences instructing the notification widget 117 to provide notification at scheduled intervals and/or when certain events occur that may affect the customer's account(s). For example, the customer 102 may input preferences such that the notification widget 117 provides notification in the event the notification widget 117 has identified an online tutorial directed to a topic that may be of interest of the customer 102. Also, for example, the customer 102 may input preferences such that the notification widget 117 provides notification when a transaction occurs in one of the customer's account(s). For example, the customer 102 may input preferences such that the notification widget 117 provides notification when a credit is made to an account, a debit is made against an account, an account balance reaches a minimum-balance amount, or an e-statement is available for online viewing.

According to an embodiment, instead of accessing the notification widget 117 to directly input notification preferences, the customer 102 logs into online banking to input notification preferences. For example, the customer 102 may access online banking and input his preferences as to how and when the notification widget 117 will notify him. In an embodiment, the customer 102 not only indicates that what type of notifications he would like to receive, such as notifications that summarize his financial transactions or indicate that a new online tutorial is available, but he also provides information relating to how he would like to receive such notifications. For example, the customer 102 can select a preference that, each time a notification arrives, the notification widget 117 makes an audible chime, provides a new-message popup on the desktop of the customer computer system 110, or provides a new-message symbol in the taskbar or dock of the desktop of the customer computer system 110.

In addition to communicating his preference regarding when and how the notification messages should be provided or transmitted, the customer 102, according to an embodiment, can input his preference as to how often to receive such notification messages. For example, the customer 102 may wish to receive the notification message corresponding to a particular transaction immediately after the bank becomes aware that a transaction affecting his account has been made. Also, for example, the customer 102 may wish to receive the notification message corresponding to a particular online tutorial immediately after the online tutorial is made available. Alternatively, the customer 102 may wish to only receive notification messages on a periodic basis, for example once a day, once every two days, or once a week. In such an instance, the notification message transmitted or otherwise made available to the customer 102 would include multiple notices, rather than a single notice.

Further, according to an embodiment, the customer 102 may only wish to receive notification messages for certain types of events and transactions, such as a new tutorial is available, withdrawals, deposits, purchases, fraud alert, new online tutorial, etc. Also, in an embodiment, the customer 102 may identify a particular vendor, or a particular type of vendor, for example, clothing stores, and indicate that he would only like to receive notification messages for transactions conducted with that vendor or that type of vendor. The customer 102 may also, in an embodiment, have selected to only receive notification messages summarizing the financial transactions affecting an account if the financial transactions involve the transfer of money over a particular threshold amount, if the financial transactions are made in particular geographic locations or if the financial transactions are made using one bank card out of multiple bank cards associated with the account. Further, in an embodiment, the customer 102 may identify a particular type of online tutorial, for example, tips or tutorials related to managing a checking account online, and indicate that he would only like to receive notification messages for that particular type of online tutorial.

During enrollment in online banking or when adjusting preferences in his online banking account or in the notification widget 117 itself, the customer 102 may also determine what information will be included in the notification message, for example, the topic of the online tutorial, the date the online tutorial will be available, the date of the transaction, the amount of the transaction, whether the transaction was a purchase, a withdrawal, a deposit, etc., and the identity of the other party involved in the transaction, including the address of such party. Indeed, it should be appreciated that there are countless ways in which the bank may wish to structure the ability of the customer 102 to provide his preferences regarding the notification messages. Thus, the customer 102 completes enrollment by indicating his preference to receive notification messages and his preferences regarding how and how often such notification messages should be communicated to him. These preferences can be updated on a forward-going basis by adjusting the notification settings in online banking or by adjusting the notification settings in the notification widget 117.

After the customer 102 has inputted notification preferences, the notification application 127 monitors the customer's account(s) to identify areas where the customer 102 could improve his use of services provided by the bank, as represented by block 610. For example, the notification application 127 monitors the customer's online banking activity to determine whether the customer underutilizes certain online banking features, such as online bill pay, and determines whether relevant online tutorials are available. Also for example, as mentioned above, the notification application 127 monitors the customer's banking behavior generally to determine whether the customer is underutilizing bank services, other than those bank services provided via online banking. For example, if, when monitoring the customer's banking behavior, the notification application 127 observes that the customer 102 only makes teller deposits at bank branch locations, then the notification application 127 makes the observation that the customer 102 could save time by making ATM deposits and determines whether a relevant online tutorial is available.

Referring still to block 610, according to an embodiment, the notification widget 117 further monitors the customer's account actively to identify transactions for which the customer 102 has indicated that he would like to receive notification messages. In an embodiment, the financial transaction is a payment made or received by the customer 102. For example, the financial transaction may be the purchase of goods or services by the customer 102 from a third party. On the other hand, the financial transaction may be the receipt of payment from a third party for services rendered by the customer 102. In an embodiment, the payment between the customer 102 and the third party may be made by credit card, debit card, check, ACH transfer, or other mutually-accepted payment mechanism and effected through the use of the POT computer system 140, which is described above with reference to FIG. 1. As used herein, the term “bank card” refers to a debit card, credit card, or any other device that is used by a customer to effectuate a financial transaction. As used herein, the term “bank card” is not limited to cards issued by banks and, instead, also includes cards and other devices issued by other financial institutions or their agents. As used herein, the term “bank account” refers to a debit account, credit account, demand deposit account, money market account, savings account, or any other type of account that may be involved in a financial transaction. In general, and in accordance with embodiments of the present invention, the POT computer system 140 processes a bank card, check or ACH transfer payment by utilizing a payment processing application 146 and communicating with the bank computer system 120 using the communication device 141 to get authorization for and/or clearance of the payment.

With regard to the nature of the POT computer system 140, the POT computer system 140 may be any type of computer system used for processing financial transactions and may be operated by or on behalf of any entity or multiple entities, including the customer 102 or the bank. Furthermore, the POT computer system 140 may be located at the point-of-transaction, or may be in a remote location. For example, if the customer 102 engages in a financial transaction by purchasing goods from a vendor using his debit card, the POT computer system 140 would generally include the computer system employed by the vendor to process the debit card payment, including, for example, the computer system of the checkout register and debit card kiosk and the computer systems of the vendor's banking institution and any intermediary financial institution. Alternatively, and for the purposes of example only, if the customer receives a payment from a third party by ACH transfer, the POT computer system 140 would generally include the computer systems employed to transfer the funds. In such a scenario, the POT computer system 140 may be owned and operated by the bank and may even be integrated with the bank computer system 120.

As another example, the customer 102 may be equipped to receive bank card payments, in which case the POT computer system 140 used to process such transactions may be owned, operated, or otherwise employed by the customer 102. In yet another example, the customer 102 may make a purchase online or through a mobile device system using the customer's mobile phone or other personal computing device. In such an embodiment, the customer's mobile phone or other personal computing device may perform the functions of bank card and bank card terminal. The mobile phone or other personal computing device may also then perform the functions of the customer computer system 110. In other words, the customer's mobile phone or other personal computing device may serve as both the customer computer system 110 and a portion of the POT computer system 140, and a vendor server interacting with the customer's mobile phone or other computing device over a network may serve as another portion of the POT computer system 140. Therefore, it will be understood that, while the POT computer system 140 is illustrated in FIG. 1 as separate from the customer computer system 110 and the bank computer system 120, it is possible that the customer computer system 110 or the bank computer system 120 could be combined with the POT computer system 140 and/or perform all of the functions attributed to the POT computer system 140. In other words, in an embodiment, the separations between the computer systems illustrated in FIG. 1 may be conceptual and one or more of the computer systems or portions thereof may be combined with one or more other computer systems or portions thereof.

According to an embodiment of the invention, the financial transaction itself may take on forms different from a credit card, debit card, check, or ACH transfer payment involving the customer 102 and a third party. For example, in one embodiment, the financial transaction is a transfer of funds between multiple account(s) held by the customer 102. In other embodiments, the financial transaction is a withdrawal from or a deposit to an account of the customer 102, whether by ATM machine, teller, or otherwise. In each of the foregoing examples, because the bank may be the entity processing the transfer, withdrawal, deposit, or clearance of the check from the account of the customer 102, the POT computer system 140 may be operated by or on behalf of the bank. Therefore, as discussed above, it may be the case that the POT computer system 140 is not distinct from the bank computer system 120 and that these two computer systems are one and the same. As a general note, the examples of financial transactions provided herein should not limit the type of financial transaction that may be the subject of the present invention, and, indeed, any financial transaction that causes an entry to be made by the bank (using the bank computer system 120) in an account of the customer 102 is suitable for the methods of embodiments of the present invention, whether such entry is a debit, credit, or otherwise.

As described above, where the financial transaction involving the customer 102 involves the debiting or crediting of a customer's bank account, the financial transaction is processed by the POT computer system 140 and the bank computer system 120 working in communication with one another. More specifically, the POT computer system 140 uses the communication device 141 and the payment processing application 146 to communicate to the bank computer system 120 information regarding the transaction to be carried out, including the amount of money at issue and the origin and destination of that money, as well as information identifying the customer 102 and/or the particular account belonging to the customer 102 that is affected by the transaction. The bank computer system 120 uses the information communicated from the POT computer system 140 to process the financial transaction within the bank. Essentially, the information communicated by the POT computer system 140 includes instructions to the bank computer system 120 to debit, credit, or otherwise adjust a particular account of the customer 102.

As described above, according to an embodiment, the customer's notification preferences are stored, for example, in the memory device 123 of the bank computer system 120 in relation to the account of the customer 102 so that the bank could locate the information whenever an area where the customer 102 could more effectively leverage bank services is identified or whenever a transaction affecting the customer's account(s) is processed. More particularly, the notification application 127, identifying an area in need of improvement or a transaction affecting the account of the customer 102, records the details of the area in need of improvement or the transaction in the account and instructs the processing device 122 to determine whether there is information stored in the memory device 123 that instructs the bank to transmit or otherwise make available to the customer 102 a notification message corresponding to the observation. In the event the customer 102 has stated a preference of receiving notification messages, the banking computer system 120, according to an embodiment, will also determine how to transmit or otherwise make available to the customer 102 a notification message. Such a determination may be made at the same time or after the bank determines that the customer 102 has stated a preference to receive notification messages.

In other embodiments, the customer's notification preferences are stored in the notification widget 117 of the customer computer system 110. In this case, the notification application 127 of the bank computer system 120 transmits a notification message corresponding to an observation to the customer computer system 110 upon making the observation, and the notification widget 117, based on the customer's preferences, determines when and how to provide the customer 102 with a notification message.

According an embodiment, and as represented by block 616, the notification application 127 of the bank computer system 120 will query the notification preference information stored in the memory device 123 in relation to the account of the customer 102 and will determine if notification messages should be immediately sent to the customer 102. In the event the customer 102 indicated a preference to receive the notification messages as soon as possible after the observation, or if the default messaging option in the notification messaging program is to have the notification messages immediately sent, the notification application 127 automatically generates an notification message and transmits the message to the notification widget 117, which is running on the customer computer system 110. In an embodiment, the message is encrypted for security purposes. In such embodiments and as described further below, the message may be decrypted after receipt by the customer computer system 110 by the notification widget 117 or other application stored on the memory device 113.

If the customer 102 has not indicated a preference to receive notification messages immediately and/or if sending notification messages immediately is not the default mode of the program, the notification application 127 will determine if it should wait to send notification message. For example, the customer 102 may have indicated a preference to only receive notification messages when a certain number of observations, such as ten, have been processed by the bank computer system 120 that affect the account of the customer 102. Or the customer 102 may have indicated a preference to only receive notification messages once a day, once a week, or some other time period. In such instances, the bank computer system 120 transmits a notification message containing a summary of the observations at the predetermined time or when the predetermined number of observations has been made. The bank computer system 120 may generate the notification message summarizing the observation immediately and hold it for transmission at a later time with other notification messages corresponding to observations made during the relevant time period.

However, in an embodiment, the message that is eventually sent is a master message that contains information corresponding to multiple observations. Thus, the bank computer system 120 is configured to identify the observations that will be the subject of a future notification message, and once the predefined number of observations have been made or the predefined period of time has lapsed, the bank computer system 120 generates a master notification message containing information summarizing all observations made during the relevant period affecting the account of the customer 102 that should be sent to the customer 102 according to the stored preference information. The bank computer system 120 uses the notification application 127 to transmit the message(s) to the notification widget 117 of the customer computer system 110.

Referring still to block 616, according to an embodiment, instead of the notification application 127 querying the customer's notification preferences before sending a notification to the customer computer system 110, the notification application 127 transmits a notification message each time the notification application 127 makes an observation. Upon receipt of the notification message from the notification application 127, the notification widget 117 of customer computer system 110 determines when and how to notify the customer 102.

The customer 102 uses the notification widget 117, which runs on the customer computer system 110, to view the notification message(s) received from the bank computer system 120. In the event the message has been encrypted for transmission, for example, for security reasons, the notification widget 117 or another application stored in the memory device 113 may be configured to decrypt the message. In an embodiment, such decryption application, whether such application is the notification widget 117 or another application, is a customized application offered by the bank to the customer 102. For example, the customer 102 may download the application onto the customer computer system 110 from the bank computer system 120 over the Internet. The application may be offered for download via online banking. Thus, according to an embodiment, the customer 102 utilizes a previously downloaded application to decrypt an encrypted message received from the bank. For convenience purposes, such downloaded application shall be considered a part of the notification widget 117, however, it should be understood that these could be separate applications. According to an embodiment, upon the communications device 111 receiving the message, the notification widget 117 automatically communicates the notification message to the customer 102.

According to an embodiment, as represented by block 620, the notification message prompts the customer 102 to log into online banking to obtain detailed information about the notification message. For example, if the notification is related to a checking account transaction, the notification message prompts the customer 102 to log into online banking, access his checking account, and review the relevant transaction. Also, for example, if the notification message is related to an online tutorial, the notification message prompts the customer 102 to log into online banking and, once the user has logged into online banking, the notification application 127 of the banking computer system 120 instructs the onboarding application 126 to launch the onboarding hub 128, as represented by block 626. The notification application 127 provides further instruction indicating which tutorial the onboarding hub 128 should provide to the customer 102.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus comprising:
a communication device;
a memory device comprising information about transactions that occur in an account that is associated with a customer; and
a processing device communicably coupled to the communication device and the memory device, wherein the processing device is configured to:
access the memory device to monitor the information about transactions that occur in the account;
make an observation about the use of the account by the customer based on the information about transactions that occur in the account; and
use the communication device to communicate the observation in the form of a notification message to an application running on a computer system associated with the customer.

2. The apparatus of claim 1, wherein, upon receipt of a notification message, the application running on the computer system associated with the customer alerts the customer that a notification message has arrived.

3. The apparatus of claim 1, wherein the notification message provides a brief summary of the observation.

4. The apparatus of claim 1, wherein the observation relates to a feature of online banking that the customer is underutilizing.

5. The apparatus of claim 4, wherein the notification message instructs the customer to log into an online banking website to view a tutorial regarding how to use the feature of online banking that the customer is underutilizing.

6. The apparatus of claim 1, wherein the observation relates to the underutilization by the customer of a financial service provided by a financial institution that administers the account.

7. The apparatus of claim 6, wherein the notification message instructs the customer to log into an online banking website to view a tutorial regarding how to use the financial service provided by a financial institution that the customer is underutilizing.

8. The apparatus of claim 1, wherein the observation relates to a financial transaction that occurred in the account.

9. The apparatus of claim 8, wherein the notification message comprises the date of the financial transaction, the amount of the financial transaction, or the identity of a party involved in the transaction.

10. The apparatus of claim 1, wherein the information about the account further includes information about when to communicate notification messages to the computer system associated with the customer.

11. The apparatus of claim 1, wherein information about when to communicate notification messages to the customer is stored in the computer system and access by the application that generates the notification messages.

12. A method comprising:
storing in a memory device information about transactions that occur in an account that is associated with a customer; and
using a processing device to:
access the memory device to monitor the information about transactions that occur in the account;
make an observation about the use of the account by the customer based on the information about transactions that occur in the account; and
instruct a communication device to communicate the observation in the form of a notification message to an application running on a computer system associated with the customer.

13. The method of claim 12, further comprising:
using the processing device to alert the customer when the notification message arrives.

14. The method of claim 12, wherein the notification message provides a brief summary of the observation.

15. The method of claim 14, wherein the observation relates to a feature of online banking that the customer is underutilizing.

16. The method of claim 15, wherein the notification message instructs the customer to log into an online banking website to view a tutorial regarding how to use the feature of online banking that the customer is underutilizing.

17. The method of claim 14, wherein the observation relates to the underutilization by the customer of a financial service provided by a financial institution that administers the account.

18. The method of claim 17, wherein the notification message instructs the customer to log into an online banking website to view a tutorial regarding how to use the financial service provided by a financial institution that the customer is underutilizing.

19. The method of claim 12, wherein the observation relates to a financial transaction that occurred in the account.

20. The method of claim 19, wherein the notification message comprises the date of the financial transaction, the amount of the financial transaction, or the identity of a party involved in the transaction.

21. A computer program product for providing notification messages to a customer associated with an account, the computer program product comprising a non-transitory computer-readable medium having computer-readable program instructions stored therein, wherein said computer-readable program instructions comprise:
first instructions configured for storing in a memory device information about transactions that occur in the account that is associated with the customer;
second instructions configured for accessing the memory device to monitor the information about transactions that occur in the account;
third instructions configured for making an observation about the use of the account by the customer based on the information about transactions that occur in the account; and
fourth instructions configured for instructing a communication device to communicate the observation in the form of a notification message to an application running on a computer system associated with the customer.

22. The computer program product of claim 21, further comprising:
instructions configured for alerting the customer when the notification message arrives.

23. The computer program product of claim 21, wherein the notification message provides a brief summary of the observation.

24. The computer program product of claim 23, wherein the observation relates to a feature of online banking that the customer is underutilizing.

25. The computer program product of claim 24, wherein the notification message instructs the customer to log into an online banking website to view a tutorial regarding how to use the feature of online banking that the customer is underutilizing.

26. The computer program product of claim 23, wherein the observation relates to the underutilization by the customer of a financial service provided by a financial institution that administers the account.

27. The computer program product of claim 26, wherein the notification message instructs the customer to log into an online banking website to view a tutorial regarding how to use the financial service provided by a financial institution that the customer is underutilizing.

28. The computer program product of claim 21, wherein the observation relates to a financial transaction that occurred in the account.

29. The computer program product of claim 28, wherein the notification message comprises the date of the financial transaction, the amount of the financial transaction, or the identity of a party involved in the transaction.
